(19) United States
(12) Patent Application Publication
(10) Pub. No.: US 2018/0021734 A1
(43) Pub. Date: Jan. 25, 2018

(54) WATER TREATMENT SYSTEM AND METHOD FOR TREATING WATER LOCATED IN A WATER RESERVOIR

(71) Applicant: VEDER Waterbox GmbH, Eugendorf (AT)

(72) Inventors: Harald EDER, Eugendorf (AT); Volker VIECHTBAUER, Fuschl am See (AT)

(73) Assignee: VEDER Waterbox GmbH, Eugendorf (AT)

(21) Appl. No.: 15/538,303

(22) PCT Filed: Dec. 22, 2015
(86) PCT No.: PCT/AT2015/050328

§ 371 Date: Jun. 27, 2017

(30) Foreign Application Priority Data
Dec. 22, 2014 (AT) A 50937/2014

(51) Int. Cl. B01D 65/02; B01D 61/14; C02F 1/28; C02F 1/44; B01D 15/36; C02F 1/68; C02F 1/50; C02F 1/42; C02F 103/42; C02F 103/00

(52) U.S. Cl. CPC B01D 65/02; C02F 1/50; B01D 61/145; C02F 1/283; C02F 1/42; C02F 1/444; B01D 15/361; C02F 1/68; B01D 2317/04; B01D 2321/185; B01D 2321/16; B01D 2321/04; C02F 2103/007; C02F 2303/16; C02F 2209/03; C02F 2209/40; C02F 2301/046; C02F 2303/04; C02F 2103/42

(57) ABSTRACT

The invention relates to a water treatment system (1) and a method for treating water (2) located in a water reservoir (3). The water treatment system (1) comprises a recirculation means (4) and a membrane filtration means (9) with a plurality of filter modules (10) disposed in the recirculation means (4). The water treatment system (1) particularly comprises a gas supply means (24) by which gas can be introduced into the filter modules (10) to clean the membranes of the filter modules (10) of the membrane filtration means (9) or by which gas supply means (24) gas can be introduced into the water reservoir (3) at one or more locations, periodically or when required, to circulate and mix up the water (2).

The invention relates to a water treatment system for treating water located in a water reservoir and a method for treating water located in a water reservoir. In particular, the invention relates to a water treatment system and a method for cleaning and disinfecting water which comes into contact with humans or animals, for example water in swimming pools or swimming ponds, or water in aquariums and such like.

Due to environmental effects, water in water reservoirs is exposed to a permanent intake of contaminants, in particular contaminants in the form of particles. For example, inorganic and organic substances, particles and micro-particles from the air are permanently being absorbed by the water. In addition, particulate contaminants can also be introduced by people or animals, in particular insects. In the case of water provided for use by humans, for example for bathing or swimming, microorganisms and germs introduced into the water may be regarded as potentially hazardous, in particular damaging to health. Such microorganisms, for example bacteria, fungi or microscopic algae, tend to be deposited on the surfaces of a water reservoir facing the water, where they multiply. Such deposits of germs form in particular in stagnating flow conditions, in other words if the water in the water reservoir is barely moving and there is no circulation.

In order to disinfect water in water reservoirs, for example swimming pools, bathing pools and such like, it is standard practice to treat or disinfect the swimming or bathing water by means of germicidal chemicals. In most cases, the disinfectants used are halogen-based, in particular contain chlorine or bromine. In order to obtain a sufficient disinfecting action, it is necessary to use considerable concentrations of these disinfectants, especially in water that is frequently used by humans. One of the disadvantages of this is the fact that such disinfectants can cause irritation to the skin and/or mucous membranes. Furthermore, the use of disinfectants which release halogens often causes unpleasant odors.

In the more recent past, efforts have been made and tests conducted with a view to replacing disinfectants containing halogens or at least to keep the requisite quantity of such disinfectants containing halogens as low as possible. Amongst other things, tests have been conducted whereby water in swimming pools has been treated using membrane filtration systems in order to remove microorganisms and germs.

However, there is still a need for optimization, especially with regard to the treatment and operating efficiency of such water treatment methods and treatment systems. Accordingly, the objective of the invention is to propose a water treatment system and a method for treating water whereby the cleaning and operating efficiency of treatments carried out in water located in water reservoirs can be improved.

The objective of the invention is achieved firstly due to the fact that an improved water treatment system for treating water located in a water reservoir, for example in a swimming pool, pond or aquarium, is proposed, in particular for cleaning and disinfecting the water.

The water treatment system comprises a recirculation means having a pumping device, one or more extraction line(s) for removing a pre-settable quantity of water from the water reservoir per unit of time, and one or more return line(s) for returning the water to the water reservoir. The water treatment system further comprises a membrane filtration means disposed in the recirculation means, which comprises a number of filter modules fluidically connected in a parallel arrangement. Accordingly, the filter modules are connected to the extraction line or lines by pipes that can be selectively shut off or opened to permit circulation on the intake side and on the filtrate side are connected to the return line or lines by pipes that can be selectively shut off or opened to permit circulation. Furthermore, in order to clean the filter modules, the filter modules are connected to a backwashing liquid source by pipes that can be selectively shut off or opened to permit circulation on the filtrate side and the filter modules are connected to a discharge by pipes that can be selectively shut off or opened to permit circulation on the intake side.

In particular, a gas supply means is provided, which, for cleaning the filter modules, is connected to the filter modules of the membrane filtration means by pipes that can be selectively shut off or opened to permit circulation on the intake side so that all of the filter modules can be flushed with gas, and which gas supply means is also connected to the return line or lines of the recirculation means by pipes that can be selectively shut off or opened to permit circulation for circulating and mixing the water in the water reservoir.

Filter modules of membrane filtration systems usually contain a plurality of microporous filter membranes, for example flat or hollow fiber membranes. The filtering action of a membrane is characterized by the fact that the water flows through the membrane walls and the particles to be removed, for example cultures of microorganisms, are held back on one side of a membrane. The expressions “on the intake side” and “intake side” as used above and below should be understood as meaning that side of the filter module from which the water to be filtered is introduced into a filter module during the filtration process. The expressions “on the filtrate side” or “filtrate side” as used above and below should be understood as meaning that side of the filter module at which the water filtered during the filtration process is drawn off from a filter module

When a filter module of the membrane filtration means is being operated in filtration mode, the quantity of particles in the filter module increases due to the particles retained on the intake side. Over the course of time, this leads to a build-up of deposits on the corresponding membrane surfaces of a filter module on the intake side, which can impair the ongoing water treatment operation. For this reason, the filter modules of the membrane filtration means have to be cleaned at specific time intervals, in particular by backwashing the filter module, regardless of how contaminated the water in the water reservoir is. To this end, the filter modules can be shut off from the extraction and return lines of the recirculation means and the filter modules cleaned with the backwashing liquid by reversing the direction of flow compared with that of the filtration operation.

Due to the features of the proposed water treatment system, the gas supply means can be used on the one hand to flush the membranes of the filter modules with a gas on the intake side. Flushing with gas in this manner is particularly practical as a means of detaching deposits of particles and bacteria from the membrane walls during a flushing operation and cleaning the membranes of the filter modules on the intake side. Deposits on the intake side of the membrane walls can be broken up and removed from the membrane walls by the gas introduced. In addition, the membranes can be placed in more vigorous motion or deformed by the gas introduced into the filter module. As a result of the deformation and agitation of the membranes, mechanical forces can be generated, for example due to friction and deformation, which also help to break up and detach particulate deposits from the membranes. By flushing the membranes of a filter module on the intake side in this manner with a gas, for example compressed air, the permeability of the membranes can be improved again in particular and the quantity of water flowing through the membranes increased again. The deposits detached from the membrane surfaces with the assistance of the gas can be disposed of during a flushing operation by means of the backwashing liquid via the discharge. Backwashing also enables deposits to be removed from the membrane pores. In particular, so-called biofouling of the membranes can be effectively prevented.

Due to the features of the proposed water treatment system however, gas can also be introduced directly into the water reservoir by the gas supply means. This promotes circulation and mixing of the water in the water reservoir and can prevent the water in the water reservoir from stagnating. As a further consequence of this, the build-up of particulate deposits, in particular the build-up of bacterial deposits and the build-up of cultures of microorganisms on the surfaces of the water reservoir facing the water are counteracted. In particular, a build-up of layers of algae in the water reservoir can be prevented.

If desired, gas may naturally also be introduced as a means of increasing the wellbeing of users or bathers, in particular in the case of swimming pools or bathing pools, in which case appropriate nozzle-type gas inlet orifices may be used to generate whirlpool-type eddying in the pool for example.

In order to improve cleaning efficiency for the membranes of the filter modules, it may be of practical advantage if the filter modules comprise at least two gas inlet connectors. This being the case, gas can be introduced into a filter module from at least two different points, thereby enabling particularly turbulent gas flows to be generated in the filter module. This also means that the duration of a gas flushing operation can advantageously be reduced so that the gas supply means of the water treatment system can be used more for circulating or mixing the water in the water reservoir.

Based on another embodiment of the invention, a shut-off member co-operates with every filter module of the membrane filtration means on the filtrate side. As a result, the filter modules can be backwashed separately and independently of one another in each case by means of the backwashing liquid source by reversing the direction of flow through the filter modules. This obviates the need for expensive and large-scale systems and devices to obtain high quantities of backwashing liquid or high flow volumes of backwashing liquids, thereby enabling procurement and production costs for the water treatment system to be reduced.

Based on another embodiment, the filter modules of the membrane filtration means may be connected to the extraction line or lines via a common shut-off or flow-regulating member on the intake side, and the filter modules are connected to the discharge via a common flow-regulating or shut-off member on the intake side, and on the filtrate side, the filter modules are connected to the return line or lines of the recirculation means and to the backwashing liquid source via at least one switching means. As a result of these features, a cleaning operation can be initiated or run for the filter modules of the membrane filtration means based on a few simple means as and when required or at periodic time intervals. Accordingly, the shut-off or regulating members and/or the at least one switching means can be used to fluidically disconnect the filter modules from the extraction line or lines and/or the return line or lines and then run a cleaning operation by reversing the direction of flow through the filter modules. Having been delivered on the filtrate side by means of the backwashing liquid source, the quite highly contaminated flushing liquid which then occurs passes through a filter module directly via the common pipe connection and is disposed of via the discharge, thereby guaranteeing the most efficient operation of the water treatment system possible. During the process of backwashing a filter module, the filter module is preferably simultaneously flushed with gas on the intake side.

Based on another advantageous embodiment of the water treatment system, the backwashing liquid source may be provided in the form of a mains water supply. As a result of this feature, the filter modules can be backwashed with mains water. This also means that a backwashing medium with a relatively high degree of purity can be used for cleaning the filter modules. Furthermore, there is no need for other, more complex backwashing devices, such as, for example, backwashing pumps, filtrate tanks or such like. This being the case, an effective and at the same time cost-efficient variant of the system can be obtained for backwashing and cleaning the filter modules of the membrane filtration means. Furthermore, this also minimizes the risk of contaminants being unintentionally or undesirably introduced into the water reservoir by the water treatment system itself, at least to a large degree.

In this connection, another variant may be of advantage, whereby the filter modules are connected to the mains water supply without a pumping device connected in between. This being the case, the filter modules can be backwashed solely using the prevailing mains water supply pressure, obviating the need for additional backwashing devices. As a result, a filter module can be backwashed in a particularly energy-efficient and cost efficient manner. In particular, it has been found that if backwashing only some of the filter modules at a time and in particular just one, the prevailing mains water supply pressure is sufficient to obtain effective backwashing of the filter modules.

In order to compensate for pressure fluctuations or if the mains water is supplied at a very high water pressure, it may be expedient to provide the mains water supply for the filter modules with a pressure reducer.

Furthermore, the mains water supply may be provided with a metering device for metering cleaning chemicals into the mains water. The cleaning chemicals used may be surfactants, disinfectants or other substances, for example, as an aid to efficient cleaning of the membranes. This will further improve cleaning efficiency for the filter modules, thereby ensuring that the water treatment system can be operated with as few problems as possible.

Based on another advantageous embodiment, the recirculation means may comprise a flow sensor for detecting the quantity of water flowing through the filter module during the filtration process. As a result, a cleaning operation for the filter modules can be run when there is a drop below a pre-settable threshold value for the flow quantity. In this respect, the cleaning operation may be initiated on an automated basis, for example by a control device of the water treatment system programmed accordingly, thereby resulting in particularly efficient operation of the water treatment system.

Alternatively and/or in addition, the recirculation means may also comprise two or more than two pressure sensors for detecting the loss of pressure across the filter modules during the filtration process. This being the case, a cleaning operation can be initiated and run for a filter module if a pre-settable threshold value for the pressure loss is exceeded.

It may also be of practical advantage if the recirculation means of the water treatment system comprises an activated carbon filter. Using such an activated carbon filter also enables substances, in particular organic substances, to be removed from the water, which the membrane filtration means might not be capable of or sufficiently capable of removing from the water. In this context, these might primarily be non-particulate substances dissolved in the water. It is preferable if such an activated carbon filter is connected to the extraction line or lines of the recirculation means by pipes that can be selectively shut off or opened to permit circulation, or is connected to the return line or lines of the recirculation means by pipes than can be selectively shut off or opened to permit circulation so that the water in the recirculation means can be selectively directed across the activated carbon filter or diverted away from the activated carbon filter via a bypass line.

Based on another advantageous embodiment of the water treatment system, the recirculation means may comprise an ion exchanger for removing ionic nutrients. This being the case, in addition to removing microorganisms by means of the membrane filtration means, the underlying cause of the breeding of microorganisms can also be at least partially removed so that the growth of microorganisms, for example bacterial cultures, in the water can be suppressed to a greater degree or at least the breeding of microorganisms reduced. It would naturally also be possible to use both anion exchangers and/or cation exchangers with a view to removing nutrient ions in anionic and/or cationic form from the water.

Furthermore, the water treatment system may comprise a metering device for adding fragrances to the water. Such a metering device may be incorporated in the flow system of the recirculation means or the water reservoir itself. Fragrances may be added to the water in particular as a means of enhancing the wellbeing of persons, for example bathers. It is possible in particular for fragrances to be added by the treatment elements of the proposed water treatment system, which at least largely or mostly obviates the need to add chemical disinfectants which contain or release chlorine to the water.

Another advantageous embodiment of the water treatment system may be configured so that a metering device for adding substances with an antimicrobial effect to the water is provided. In this manner, antimicrobial substances such as silver nanoparticles, for example, can be introduced into the water, thereby enabling the water quality to be improved even further.

Another advantageous embodiment of the water treatment system is one where the number and filtration capacity of the filter modules are selected so that a removal rate of microorganisms that is greater than the growth rate of the microorganisms in the water over the same period can be achieved by recirculating and filtering the water. This effectively prevents an increase in the total quantity of microorganisms in the water without the need to use disinfectants for this purpose.

Finally, it may also be of practical advantage to select the number and filtration capacity of the filter modules so that the volume of water contained in the water reservoir overall can be filtered by the membrane filtration means at least once a day and preferably between 2 times and 10 times. In this manner, a sufficient quantity of water can be treated and/or cleaned by the water treatment system per day.

The objective of the invention is also achieved by a method for treating water located in a water reservoir, for example in a swimming pool, pond or aquarium, in particular for cleaning and disinfecting the water. The method comprises the following method steps:
removing a pre-settable quantity of water per unit of time from the water reservoir via one or more extraction line(s) of a recirculation means;
filtering the removed partial quantity of water by means of a membrane filtration means disposed in the recirculation means, the membrane filtration means comprising a number of filter modules fluidically connected in a parallel arrangement,
returning the water to the water reservoir via one or more return line(s) of the recirculation means;
cleaning the membranes of the filter modules, periodically or when required, by backwashing with a backwashing liquid by reversing the direction of flow through the filter modules compared with that of the filtration operation and discharging the dirty liquid occurring during backwashing via a discharge.

In particular, in order to clean the membranes of the filter modules of the membrane filtration means, gas is introduced by a gas supply means into the filter modules on the intake side or the gas is introduced into the water reservoir at one or more locations by the gas supply means, periodically or when required, to circulate the water in the water reservoir.

Due to the method features, only a gas supply means is needed to clean the membranes of a filter module of the membrane filtration means by applying gas, on the one hand, and to assist circulation and mixing of the water in the water reservoir to prevent the water in the water reservoir from stagnating, on the other hand. During the course of an operation for cleaning the filter membrane surfaces by flushing them with gas, the filter modules are preferably also backwashed by reversing the direction of flow compared with that used for the filtration operation in order to improve cleaning efficiency. Deposits detached from the membrane surfaces by means of the backwashing liquid can be disposed of via the discharge. Backwashing also enables deposits to be removed from the membrane pores. In particular, so-called biofouling of the membranes can be effectively prevented in this manner.

The gas is preferably introduced into the water reservoir from as many points in the water reservoir as possible in order increase the effectiveness of mixing the water and causing turbulence in the water reservoir. The advantageous way the gas is introduced into a filter module and into the water reservoir was explained above in detail and will therefore not be described again at this point. Due to the features proposed by the invention, the method for treating water can be operated particularly efficiently.

Based on another embodiment of the method, an operation for cleaning the membranes of the filter modules can be run in such a way that gas is introduced simultaneously into all the filter modules on the intake side and then pre-settable partial quantities of the filter modules can be sequentially backwashed with the backwashing liquid by reversing the direction of flow through the filter modules. This obviates the need for larger-scale operations and devices to provide large quantities of backwashing liquid and high flow volumes of backwashing liquid, thereby increasing the operating and cost efficiency of the method. At the same time, however, a high cleaning efficiency can be achieved because deposits on the membrane surfaces can be broken up and detached in an effective manner by the flushing gas by continuously flushing all the filter modules with gas during the entire cleaning operation. These already loosened deposits can then be removed from a filter module by backwashing.

However, an operation for cleaning the membranes of the filter modules can also be run in such a way that gas is introduced simultaneously into all the filter modules on the intake side, after which each filter module is sequentially individually backwashed with the backwashing liquid by reversing the direction of flow through the filter modules. This makes the method particularly efficient in terms of cost and operation.

It may also be of practical advantage if the filter modules are backwashed with mains water. As a result of this method feature, the cleaning efficiency for a filter module is improved even further because a relatively clean backwashing liquid can be used. The mains water is directed through the filter modules by reversing the direction of flow compared with that used for the filtration operation. Loosened deposits on the intake-side membrane surfaces assisted by the gas can then be efficiently removed from the membrane surfaces by this mains water flow and directed out of the filter modules and via the discharge.

The cleaning efficiency for a filter module can be even further improved if cleaning chemicals are added to the mains water when backwashing. These might be, for example, surfactants, disinfectants or other substances to make cleaning of the membranes more efficient.

Another advantageous embodiment of the method for treating water is one whereby a filter module is backwashed with a flow volume of backwashing liquid of between 70 l/m²ₘₑₘ*h and 700 l/m²ₘₑₘ*h and with a flow speed of the backwashing water through the filter module of between 0.02 m/s and 1.0 m/s. The above-mentioned figures for the volume of backwashing liquid in l/m²*h denote the volume of backwashing liquid in liters per square meter of membrane surface of the filter module and per hour. The specified ranges for the volume of backwashing liquid and flow speed of the backwashing liquid, in particular mains water, through a filter module have been found to be particularly expedient in terms of obtaining efficient cleaning of the membranes of a filter module, thereby ensuring an efficient way of running the water treatment method with as few problems as possible. The flow speed of the backwashing liquid and/or backwashing water through a filter module can be influenced taking account of the prevailing liquid pressure, for example the prevailing mains water pressure, amongst other things based on the structural design and/or size of the casing of a filter module. For example, the flow speed of the backwashing liquid through a filter module can be increased for a same liquid pressure by reducing the cross-sectional surface of the casing for the membranes of a filter module.

Based on another advantageous embodiment of the method, a filter module can be cleaned on the intake side with a gas flow volume of between 0.2 Nm³/m²*h and 5.0 Nm³/m²*h and a flow speed of the gas through the filter module of between 0.1 m/s and 2 m/s. The abovementioned figures for the gas flow volume in Nm³/m²*h denote the flow volume of gas in standard cubic meters per square meter of membrane surface of the filter module and per hour. The specified ranges for the gas flow volume and flow speed of the gas through a filter module have been found to be expedient in terms of obtaining efficient cleaning of the membranes of a filter module, thereby ensuring an efficient way of running the water treatment method with as few problems as possible. Again, the flow speed of the flushing gas can be influenced taking account of the prevailing gas pressure, amongst other things based on the structural design of the casing of a filter module. For example, the flow speed of the gas through a filter module for the same gas pressure can be increased by reducing the cross-sectional surface of the casing for the membranes of a filter module.

It may also be of practical advantage if, in order to end an operation for cleaning and flushing a filter module, the intake of mains water into the filter module is halted, the backwashing water remaining in the filter module is displaced by the gas and directed away via a discharge, and the filter module is filled with mains water before resuming the filtration operation. On the one hand, this ensures that soiled flushing water that has been used for backwashing is completely removed from a filter module. On the other hand, the filter module can be filled with clean water again before the filtration operation is resumed, thereby effectively preventing contaminants from being undesirably or unintentionally introduced into the water reservoir.

Based on another advantageous embodiment, the flow quantity of water through the filter modules is detected during the filtration process and an operation for cleaning the filter modules is initiated when there is a drop below a pre-settable threshold value for the flow quantity. In this respect, the cleaning operation may be initiated on an automated basis, for example by a control device of the water treatment system programmed accordingly, thereby enabling a particularly efficient way of running the method for treating water to be obtained.

Alternatively and/or in addition, however, the pressure loss across the filter modules is detected during the filtration process and an operation for cleaning the filter modules is initiated when a pre-settable threshold value for the pressure loss is exceeded.

It may also be of practical advantage if, in order to circulate the water in the water reservoir, an average total quantity of gas is introduced into the water reservoir with a gas flow volume of between 0.05 Nm³/m³_{wr}*h and 5 Nm³/m³_{wr}*h at periodic time intervals. Introducing gas based on a gas flow volume in this range has been found to be effective in terms of ensuring sufficient circulation and mixing of the water in the water reservoir. In this manner, the formation of deposits, for example the formation of layers of algae, in the water reservoir can be effectively prevented. The above-mentioned figures for the gas flow volume in

Nm³/m³*h denote the gas quantity in standard cubic meters per cubic meter of water in the water reservoir and per hour.

It may also be of advantage if the water is directed through an activated carbon filter fluidically incorporated in the recirculation means. Using such an activated carbon filter also enables substances that cannot be removed by the membrane filtration means or cannot be so sufficiently well, in particular organic substances, to be removed from the water. These may primarily be non-particulate substances dissolved in the water. It is preferable if such an activated carbon filter is connected to the extraction line or lines of the recirculation means by pipes that can selectively shut off or opened to permit circulation or is connected to the return line or lines of the recirculation means by pipes that can selectively shut off or opened to permit circulation so that the water in the recirculation means can be selectively directed across the activated carbon filter or diverted away from the activated carbon filter via a bypass line.

It may also be of practical advantage if ionic nutrients are removed from the water by means of ion exchangers fluidically incorporated in the recirculation means. This being the case, in addition to removing microorganisms by means of the membrane filtration means, the underlying cause of the breeding of microorganisms can also be at least partially removed so that the growth of microorganisms, for example bacteria cultures, in the water can be suppressed to a greater degree or at least the breeding of microorganisms reduced. It would naturally also be possible to use both anion exchangers and/or cation exchangers with a view to removing nutrient ions in anionic and/or cationic form from the water.

Based on another variant of the method, fragrances may be added to the water by means of a metering device. Fragrances may be added to the water in particular as a means of enhancing the wellbeing of persons, for example bathers.

It may also be of practical advantage if substances with an antimicrobial effect are added to the water by means of a metering device. In this manner, antimicrobial substances such as silver nanoparticles, for example, can be introduced into the water, thereby enabling the water quality to be improved even further.

It may also be of advantage to operate the method in such a way that the partial quantity of water removed from the water reservoir by the recirculation means per unit of time is selected so that a removal rate of microorganisms that is greater than the growth rate of the microorganisms in the water over the same period can be achieved by recirculating and filtering the water. This effectively prevents an increase in the total quantity of microorganisms in the water without the need to use disinfectants for this purpose.

Finally, another way of running the method is one whereby the partial quantity of water removed from the water reservoir by the recirculation means per unit of time is selected so that the volume of water contained in the water reservoir overall can be filtered by the membrane filtration means at least once a day and preferably between 2 times and 10 times. In this manner, a sufficient quantity of water can be treated and/or cleaned by the water treatment system per day.

To provide a clearer understanding, the invention will be described in more detail below with reference to the appended drawing.

This is a highly simplified, schematic diagram illustrating the following:

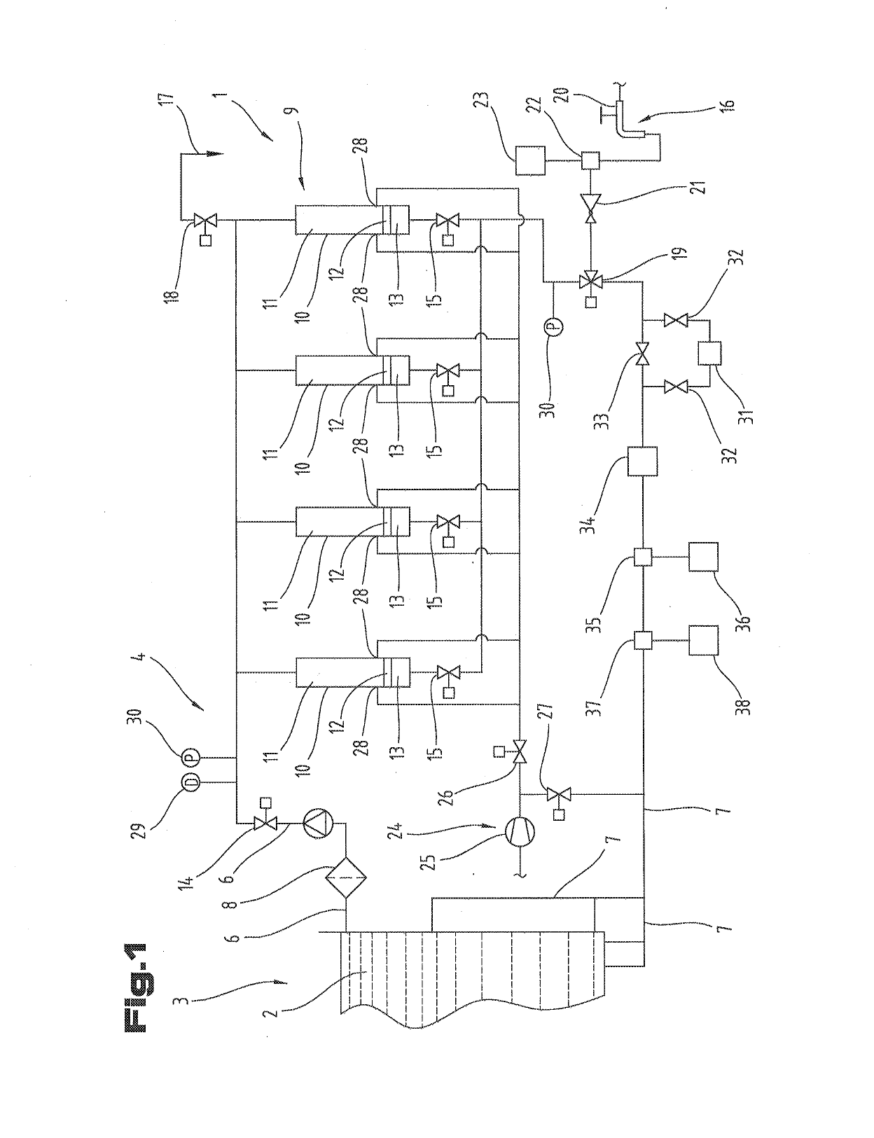

FIG. 1 a water treatment system for treating water located in a water reservoir, based on a very simple, schematic diagram.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

FIG. 1 illustrates one example of an embodiment of a water treatment system 1 for treating water 2 proposed by the invention, in particular for cleaning and disinfecting water 2. The water to be treated 2 is located in the partially illustrated water reservoir 3. The water reservoir 3 may be a swimming pool, a pond, an aquarium or similar water containers, for example. In principle, it may be an artificial or natural water reservoir 3.

As illustrated in FIG. 1, the water treatment system 1 comprises a recirculation means 4, by means of which a pre-settable quantity of water 2 can be removed from the water reservoir 3 per unit of time and treated. To this end, at least one pumping device 5 as well as one or more extraction line(s) 6 and one or more return line(s) 7 are provided. The extraction line(s) 6 are preferably connected to the water reservoir 3 at or close to the water surface because in most cases it is at the surface that the water 2 contains the most dirt and contaminants. The return line(s) 7 are preferably connected to the water reservoir 3 at points at a greater depth and at the largest number of points in order to generate better mixing in the water reservoir 3 due to circulation of the water 2. The pumping device 5 may be a feed pump, circulating pump, recirculating pump or similar, for example. The pumping device 5 is preferably a speed controllable pump so that the quantity of water 2 removed from the water reservoir 3 for treatment per unit of time can be adjusted as and when required during ongoing operation.

In order to remove relatively large contaminants such as leaves, insects, etc., a filter unit 8 for coarse particles may be provided in the extraction line or lines 6, such as a sand filter or a conventional screen filter, for example. Such filter units 8 are preferably disposed in the extraction line or lines 6 close to the extraction point or points from the water reservoir and thus constitute the first element for removing contaminants from the water 2.

As also illustrated in FIG. 1, a membrane filtration means 9 is disposed in the recirculation means 4. The membrane filtration means 9 comprises a number of filter modules 10 fluidically connected in a parallel arrangement. By way of example, four filter modules 10 are illustrated in FIG. 1 although the number of filter modules 10 used will obviously depend on the prevailing conditions and various parameters, such as the anticipated extent of contamination of the water 2 or the filtration capacity of an individual filter module 10 etc., for example.

The number of filter modules 10 used for the water treatment system 1 and their filtration capacity are preferably selected so that a removal rate of microorganisms that can be achieved by recirculating and filtering the water 2 is greater than the rate of growth of microorganisms in the water 2 over the same period. Furthermore, the number of filter modules 10 and their filtration capacity are preferably selected so that the volume of water 2 contained in the water reservoir 3 as a whole can be filtered by the membrane filtration means 9 at least once a day and preferably between 2 times and 10 times.

In principle, the filter modules 10 of the membrane filtration means 9 may be of various types and/or have various different features. The filter modules 10 are preferably provided in the form of hollow-fiber membrane modules containing a number of hollow-fiber membranes. The hollow fibers may be made from various materials and ceramic hollow fibers or plastic hollow fibers such as hollow fibers of polyethylene, polypropylene, polyether sulfone or similar plastics, for example, are the most commonly used. Such hollow fibers are usually of a tubular shape having two open ends and may be of various lengths. The hollow fibers are porous and water is able to flow through them from the outside to the inside and vice versa. Depending on the selected pore diameter of the hollow fiber material, particles up to a specific size will be able to pass through the membrane walls of the hollow fibers whereas larger particles will be held back on the hollow-fiber membrane walls, this being the filtering effect of a hollow-fiber membrane. For treating water in water reservoirs, hollow-fiber membranes with a pore diameter of between 0.2 □m and 0.01 □m have been found to be particularly suitable, corresponding to so-called ultrafiltration.

In the embodiment illustrated as an example in FIG. 1, the type of hollow fibers used may be those which are loosely suspended in the form of bundles or mats disposed in an intake chamber 11 located on the top side of the filter module 10. Accordingly, the respective open ends of the hollow fibers may be embedded in a sealant 12 in such a way that the inner lumens of the hollow fibers open into a filtrate chamber 13 located on the bottom side of a filter module 10. This sealant 12, for example cured epoxy resin or similar, fluidically separates the intake chamber 11 and the filtrate chamber 13 from one another so that the water 2 is only able to pass or be pumped through the hollow-fiber membrane walls—from the external surface of the hollow fibers into the inner lumen of the hollow fibers—from the intake chamber 11 into the filtrate chamber 13 and is thus filtered. The embodiment illustrated in FIG. 1 corresponds to a so-called “dead end” filtration in “outside-in” operating mode. The filter modules 10 are preferably fluid-tight and designed to be resistant to high and negative pressure.

In order to feed the water 2 into the intake chamber 11 of a filter module 10, the filter modules 10 are connected on the intake side to the extraction line or lines 6 of the recirculation means 4 by pipes that can be selectively shut off or opened to permit circulation. In order to shut off and/or open this pipe connection, a common shut-off or flow-regulating member 14 is illustrated in FIG. 1 as an example of an embodiment.

On the filtrate side, the filter modules 10 are connected to the return line or lines 7 via shut-off members 15 by means of which the pipes can be selectively shut off or opened to permit circulation, as well as to a backwashing liquid source 16. As may be seen from the embodiment illustrated as an example in FIG. 1, it is preferable to provide every filter module 10 with a shut-off member 15 on the filtrate side so that the filter modules 10 can each be backwashed independently of one another by means of the backwashing liquid source 16 by reversing the direction of flow through the filter modules, as will be explained in more detail below.

When the filter modules 10 are in filtration mode, the shut-off or flow-regulating member 14 and the shut-off members 15 are opened so that water 2 can be fed out of the water reservoir 3 via the filter modules 10, filtered and fed via the return line(s) 7 back into the water reservoir 3. In order to run a cleaning operation by reversing the direction of flow through the filter modules, the shut-off or flow-regulating member 14 can be closed in order to shut off the pipe connections of the filter module 10 to the extraction line or lines 6.

In the embodiment illustrated as an example in FIG. 1, the filter modules 10 are also connected on the intake side to a discharge 17 by pipes that can be selectively shut off or opened to permit circulation. A common flow-regulating or shut-off member 18 is provided for this purpose, which can be closed during the filtration process and opened during a cleaning and/or flushing operation.

In order to switch between filtration mode and a cleaning operation and/or cleaning mode by backwashing and/or to reverse the direction of flow through the filter modules 10, a switching means 19 is provided in the embodiment illustrated as an example in FIG. 1. By this switching means 19, a flow connection can optionally be established on the filtrate side of the filter modules 10 to the return line or lines 7 or optionally a flow connection to the backwashing liquid source 16. In filtration mode, therefore, the filtered water can be returned to the water reservoir 3, whilst in cleaning and/or backwashing mode the backwashing liquid can be introduced into a filter module 10 with the shut-off member 15 simultaneously closed on the filtrate side. During such a backwashing operation, the backwashing liquid can be introduced into the filtrate chamber 13 of a filter module 10, forcing the backwashing liquid into the inner lumens of the hollow fibers. The backwashing liquid then passes through the walls of the hollow-fiber membranes and into the intake chamber 11 of the filter module 10, and can be discharged and disposed of through the discharge 17. This corresponds to a reversal of the flow direction through a filter module 10 compared with that of a filtration operation. As an alternative to the embodiment illustrated as an example in FIG. 1, several switching means may also be provided, for example a shut-off member co-operating with the backwashing liquid source 16 and a shut-off member co-operating with the return line or lines 7.

The backwashing liquid source 16 may be provided in the form of a supply tank containing a detergent, for example, from which the detergent is conveyed by a pumping device and introduced into a filter module. As illustrated in FIG. 1, the backwashing liquid source 16 is preferably a mains water supply 20, which is in turn connected, preferably without an inter-connected pumping device, to the filter modules 10 via the switching means 19 and the shut-off members 15 can be optionally shut off or opened to permit circulation on the filtrate side. This being the case, the respectively prevailing mains water pressure can be used as the driving force for backwashing the filter modules 10.

In order to compensate for pressure fluctuations or if the mains water supply 20 has a very high water pressure, it may be expedient to provide a pressure reducer 21 in a common mains water supply for the filter modules 10. As may also be seen from the embodiment illustrated as an example in FIG. 1, it may also be expedient to provide a metering device 22 in the common mains water supply for the filter modules 10 for metering cleaning chemicals. In this manner, detergents such as surfactants or disinfectants for example, can be added to the backwashing and/or mains water in order to improve cleaning efficiency during a flushing operation. The cleaning chemicals used for this purpose may be drawn from one or more chemical source(s) 23, such as chemical tanks or some other containers suitable for storing the corresponding chemicals for example.

Irrespective of the nature or exact composition of the backwashing liquid, a filter module 10 is preferably backwashed with a flow volume of backwashing liquid of between 70 l/m²ₘₑₘ*h and 700 l/m²ₘₑₘ*h and with a flow speed of the backwashing water through the filter module of between 0.02 m/s and 1,0 m/s. Flow volumes and flow speeds of the backwashing liquid in the specified ranges have been found to be effective in terms of obtaining an efficient and as complete as possible cleaning of the hollow-fiber membranes of a filter module 10.

As may be seen from FIG. 1, the water treatment system 1 in particular comprises a gas supply means 24. To enable the filter modules 10 to be cleaned, the gas supply means 24 is connected on the one hand to the filter modules 10 of the membrane filtration means on the intake side by pipes that can be selectively shut off or opened to permit circulation. In addition, the gas supply means 24 is also connected to the return line or lines 7 of the recirculation means 4 by pipes that can selectively shut off or opened to permit circulation in order to circulate and mix the water 2 in the water reservoir 3.

The gas supply means 24 may be provided in the form of various types of gas source, for example gas bottles or gas cartridges containing suitable gases for flushing the filter modules with gas. For example, suitable gas sources in particular are those containing compressed inert gases. The gas can be fed from such gas sources to the filter modules 10 via pressure-reducing valves, for example. The gas supply means 24 is preferably provided in the form of an air blower 25.

In the embodiment illustrated as an example in FIG. 1, a common shut-off member 26 is provided as a means of selectively shutting off or opening the pipe connections between the gas supply means 24 and the intake chamber 11 of the filter modules 10. At least one other shut-off member 27 is provided as a means of selectively shutting off or opening the pipe connections between the gas supply means 24 and the return line or lines 7 of the recirculation means 4. On the one hand, this enables the hollow-fiber membranes of the filter modules 10 to be flushed with gas on the intake side. On the other hand, gas can be introduced into the water reservoir 3 from one or more points for circulating or mixing the water 2 in the water reservoir 3 periodically or when required. To ensure that the water 2 in the water reservoir 3 is sufficiently well mixed, gas is preferably introduced into the water reservoir 3 at periodic time intervals at a gas flow volume of between 0.05 Nm³/m³_{wr}*h and 5 Nm³/m³_{wr}*h. The gas supply means 24 may be used either to flush the filter modules 10 or to circulate and mix the water 2 in the water reservoir 3.

The filter modules 10 are preferably flushed with gas at the same time as the filter modules 10 are being backwashed in the manner described above, and in order to improve the cleaning efficiency of the filter modules 10, the gas is preferably introduced into the filter modules 10 from the intake side of the filter modules 10 via at least two gas inlet connectors 28.

To enable the filtration operation to be interrupted for the cleaning operation, the shut-off or flow-regulating member 14 may be closed to enable the filter modules 10 to be fluidically disconnected from the extraction line or lines 6. At the same time, the shut-off member 18 can be opened so that the filter modules can be fluidically connected to the discharge 17. Furthermore, the switching means 19 can be switched in order to fluidically disconnect the filter modules 10 from the return line or lines 7 and fluidically connect the filter modules 10 to the backwashing liquid source 16. In order to introduce gas into the intake chamber 11 of the filter modules 10, the shut-off member 26 can be opened so that all the filter modules 10 can be flushed with gas simultaneously and the flushing gas passes through the intake chamber 11 from the bottom to the top and can be fed away via the discharge 17.

An operation for cleaning the membranes of the filter modules 10 is preferably run in such a way that gas is introduced into all of the filter modules 10 simultaneously from the intake side, after which a pre-settable partial number of filter modules 10 are backwashed with the backwashing liquid by reversing the direction of flow through the filter modules 10. To this end, shut-off members 15 co-operating with partial numbers of filter modules 10 can be sequentially opened and closed from the filtrate side. For example, in cleaning mode, the two filter modules 10 illustrated on the left-hand side in FIG. 1 can be flushed with the backwashing liquid by opening the shut-off members 15 co-operating with these two filter modules 10. The backwashing operation for the two filter modules 10 illustrated on the left-hand side in FIG. 1 can then be terminated by closing the these two shut-off members 15, after which the two filter modules 10 illustrated on the right-hand side can also be flushed with backwashing liquid by opening the shut-off members 15 co-operating with these two filter modules 10. The backwashing operation for these two filter modules 10 illustrated on the right-hand side in FIG. 1 can then also be terminated by closing the shut-off members 15 co-operating with these two filter modules 10.

However, it may also be expedient to run an operation for cleaning the membranes of the filter modules 10 in such a way that gas is introduced into all of the filter modules 10 simultaneously on the intake side and then each filter module 10 is backwashed with backwashing liquid individually in sequence by reversing the direction of flow through the filter modules 10.

During the operation of cleaning the filter modules 10, a gas flow volume of between 0.2 Nm³/m²ₘₑₘ*h and 5.0 Nm³/m²ₘₑₘ*h is preferably introduced into every filter module 10 at a flow speed of the gas in the filter module of between 0.1 m/s and 2 m/s. A cleaning operation involving backwashing and simultaneously flushing the membranes of a filter module 10 with gas is preferably terminated by halting the intake of mains water to the filter module, displacing any backwashing water remaining in the filter module with gas and feeding it away via a discharge, after which the filter module is filled with mains water prior to resuming the filtration operation.

The filter modules can be cleaned at periodic, pre-settable time intervals, for example. However, it may also be expedient to clean and/or backwash the filter modules 10 assisted by gas as and when necessary. In particular, it is expedient to run a gas-assisted backwash of the filter modules 10 whenever—due to deposits on the membrane walls—a drop in the flow quantity passing through a filter module 10 is detected during the filtration operation.

In order to detect the quantity of water flowing through the filter modules 10 during the filtration process, the recirculation means 4 in the embodiment illustrated as an example in FIG. 1 comprises a flow sensor 29. Accordingly, cleaning of the filter modules 10 and/or backwashing with gas can be initiated if there is a drop below a pre-settable threshold value for the flow quantity. In principle, a cleaning operation can be initiated both manually and on an automated basis. A cleaning operation is preferably initiated and run by an appropriately programmed control device of the water treatment system 1, thereby making operation of the water treatment system 1 particularly efficient.

Alternatively and/or in addition, the recirculation means 4 may comprise at least two pressure sensors 30 for detecting the pressure loss across the filter modules 10 during the filtration process and an operation for cleaning the filter modules 10 can be initiated and run when a pre-settable threshold value for the pressure loss across the filter modules 10 is exceeded.

In order to resume the filtration operation after backwashing all the filter modules 10, the shut-off member 18 can be closed and the switching means 19 switched back to filtration mode in order to fluidically connect the filter modules 10 to the return line or lines 7 and fluidically disconnect the filter modules 10 from the backwashing liquid source 16. After opening the shut-off or flow-regulating member 14 and opening all the shut-off members 15, the filtration operation can be started again.

To further improve treatment of the water 2 in the water reservoir 3, the recirculation means 4 of the water treatment system 1 may comprise an activated carbon filter 31, as is the case with the example of an embodiment illustrated in FIG. 1. By means of such an activated carbon filter 31, non-particulate substances dissolved in the water 2, in particular low-molecular organic compounds, can be removed from the water in particular. As illustrated in FIG. 1, an activated carbon filter 31 is preferably connected to the pipes of the recirculation means 4 by pipes than can be selectively shut off or opened to permit circulation. As a result, the water 2 can be selectively directed through the activated carbon filter 31—by opening the valves 32 and closing valve 33—or the water 2 can be circulated in the water reservoir 3 without passing through the activated carbon filter 31—by opening valve 33 and closing valves 32. This may be expedient, for example, as a means of preventing the removal of desired substances from the water, for example whilst the water reservoir 3 is being used for bathing.

For all of the shut-off members and/or flow regulating members 14, 15, 18, 19, 26, 27, 32 and 33 mentioned above, it is possible to use a whole range of different shut-off members or valves for shutting off and opening pipe connections, for example so-called on/off valves. In this respect, it is also possible to use both manually operable valves or valves operated on an electronically automated basis. It is preferable to use electronically operated valves to enable the water treatment system 1 to be operated by means of automatic and/or programmable control systems. In the case of a flow regulating member, it is possible to use steplessly adjustable valves in particular.

As is the case with the embodiment illustrated as an example in FIG. 1, the recirculation means 4 may also comprise one or more ion exchangers 34. For reasons of clarity, only one ion exchanger 34 is illustrated in FIG. 1. Such ion exchangers 34 may be cation exchangers or anion exchangers and these may advantageously be used primarily for removing ionic nutrients from the water 2 by directing the water in the recirculation means 4 through one or more ion exchangers 34.

It may also be expedient to provide a metering device 35 in the recirculation means 4 of the water treatment system 1, by means of which metering device 35 substances having an antimicrobial effect can be drawn from a chemical source 36 and introduced into the water. For example, this enables silver nanoparticles to be added to the water 2.

Finally, the water treatment system 1 may comprise a metering device 37 by means of which fragrances from a fragrance source 38 can be added to the water. Such a metering device 37 is disposed in the recirculation means 4 of the embodiment illustrated as an example in FIG. 1. In principle, however, fragrances can also be added to the water reservoir 3 directly.

The embodiments illustrated as examples represent possible variants of the water treatment system and the method for treating water, and it should be pointed out at this stage that the invention is not specifically limited to the variants specifically illustrated, and instead the individual variants may be used in different combinations with one another and these possible variations lie within the reach of the person skilled in this technical field given the disclosed technical teaching.

Furthermore, individual features or combinations of features from the different embodiments illustrated and described may be construed as independent inventive solutions or solutions proposed by the invention in their own right.

The objective underlying the independent inventive solutions may be found in the description.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

Above all, the individual embodiments of the subject matter illustrated in FIG. 1 constitute independent solutions proposed by the invention in their own right. The objectives and associated solutions proposed by the invention may be found in the detailed descriptions of this drawing.

For the sake of good order, finally, it should be pointed out that, in order to provide a clearer understanding of the water treatment system, it and its constituent parts are illustrated to a certain extent out of scale and/or on an enlarged scale and/or on a reduced scale.

List of reference numbers

| | |
|---|---|
| 1 | Water treatment system |
| 2 | Water |
| 3 | Water reservoir |
| 4 | Recirculation means |
| 5 | Pumping device |
| 6 | Extraction line |
| 7 | Return line |
| 8 | Filter unit |
| 9 | Membrane filtration means |
| 10 | Filter module |
| 11 | Intake chamber |
| 12 | Sealant |
| 13 | Filtrate chamber |
| 14 | Flow regulating member |
| 15 | Shut-off member |
| 16 | Backwashing liquid source |
| 17 | Discharge |
| 18 | Shut-off member |
| 19 | Switching means |
| 20 | Mains water supply |
| 21 | Pressure reducer |
| 22 | Metering device |
| 23 | Chemical source |
| 24 | Gas supply means |
| 25 | Air blower |
| 26 | Shut-off member |
| 27 | Shut-off member |
| 28 | Gas inlet connector |
| 29 | Flow sensor |
| 30 | Pressure sensor |
| 31 | Activated carbon filter |
| 32 | Valve |
| 33 | Valve |
| 34 | Ion exchanger |
| 35 | Metering device |
| 36 | Chemical source |
| 37 | Metering device |
| 38 | Fragrance source |

1-33. (canceled)

34. Method for treating water (2) located in a water reservoir (3), for example in a swimming pool, pond or aquarium, in particular for cleaning and disinfecting the water (2), comprising:
removing a pre-settable quantity of water (2) per unit of time from the water reservoir (3) via one or more extraction line(s) (6) of a recirculation means (4);
filtering the removed partial quantity of water (2) by means of a membrane filtration means (9) disposed in the recirculation means (4), the membrane filtration means (9) comprising a number of filter modules (10) fluidically connected in a parallel arrangement;
returning the water to the'water reservoir (3) via one or more return line(s) (7) of the recirculation means (4);
cleaning the membranes of the filter modules (10), periodically or when required, by backwashing with a backwashing liquid by reversing the direction of flow through the filter modules (10) compared with that of the filtration operation and discharging the dirty liquid occurring during backwashing via a discharge (17),
wherein in order to clean the membranes of the filter modules (10) of the membrane filtration means (9), gas is introduced by a gas supply means (24) into the filter modules (10) on the intake side or the gas is introduced into the water reservoir (3) at one or more locations by the gas supply means (24), periodically or when required, to circulate the water (2) in the water reservoir (3), the gas supply means (24) being used either to flush the filter modules (10) with gas or to circulate and mix the water (2) in the water reservoir (3).

35. Method according to claim 34, wherein an operation for cleaning the membranes of the filter modules (10) is run in such a way that gas is introduced simultaneously into all the filter modules (10) on the intake side and then presettable partial quantities of the filter modules (10) are sequentially backwashed with the backwashing liquid by reversing the direction of flow through the filter modules (10).

36. Method according to claim 34, wherein an operation for cleaning the membranes of the filter modules (10) is run in such a way that gas is introduced simultaneously into all the filter modules (10) on the intake side, after which each filter module (10) is sequentially individually backwashed with the backwashing liquid by reversing the direction of flow through the filter modules (10).

37. Method according to claim 34, wherein the filter modules (10) are backwashed with mains water.

38. Method according to claim 37, wherein cleaning chemicals are added to the mains water when backwashing a filter module (10).

39. Method according to claim 34, wherein a filter module (10) is backwashed with a flow volume of backwashing liquid of between 70 l/m²ₘₑₘ*h and 700 l/m²ₘₑₘ*h and with a flow speed of the backwashing liquid through the filter module (10) of between 0.02 m/s and 1.0 m/s.

40. Method according to claim 34, wherein a filter module (10) can be cleaned on the intake side with a gas flow volume of between 0.2 Nm³/m²ₘₑₘ*h and 5.0 Nm³/m²ₘₑₘ*h and a flow speed of the gas through the filter module (10) of between 0.1 m/s and 2 m/s.

41. Method according to claim 36, wherein in order to end an operation for cleaning and flushing a filter module (10), the intake of mains water into the filter module (10) is halted, the backwashing water remaining in the filter module (10) is displaced by the gas and directed away via a discharge (17), and the filter module (10) is filled with mains water before resuming the filtration operation.

42. Method according to claim 34, wherein the flow quantity of water (2) through the filter modules (10) is detected during the filtration process and an operation for cleaning the filter modules (10) is initiated when there is a drop below a pre-settable threshold value for the flow quantity.

43. Method according to claim 34, wherein the pressure loss across the filter modules (10) is detected during the filtration process and an operation for cleaning the filter modules (10) is initiated when a pre-settable threshold value for the pressure loss is exceeded.

44. Method according to claim 34, wherein in order to circulate the water (2) in the water reservoir (3), gas is introduced into the water reservoir (3) with a gas flow volume of between 0.05 Nm³/m³_{wr}*h and 5 Nm³/m³_{wr}*h at periodic time intervals.

45. Method according to claim 34, wherein the water (2) is directed through an activated carbon filter (31) fluidically incorporated in the recirculation means (4).

46. Method according to claim 34, wherein ionic nutrients are removed from the water (2) by means of an ion exchanger (34) fluidically incorporated in the recirculation means (4).

47. Method according to claim 34, wherein fragrances are added to the water (2) by means of a metering device (22).

48. Method according to claim 34, wherein substances with an antimicrobial effect are added to the water (2) by means of a metering device (37).

49. Method according to claim 34, wherein the partial quantity of water (2) removed from the water reservoir (3) by the recirculation means (4) per unit of time is selected so that a removal rate of microorganisms that is greater than the growth rate of microorganisms in the water (2) over the same period can be achieved by recirculating and filtering the water (2).

50. Method according to claim 34, wherein the partial quantity of water (2) removed from the water reservoir (3) by the recirculation means (4) per unit of time is selected so that the volume of water (2) contained in the water reservoir (3) overall can be filtered by the membrane filtration means (9) at least once a day and preferably between 2 times and 10 times.

51. Water treatment system (1) for implementing the method according to claim 34, comprising
a recirculation means (4) having a pumping device (5), one or more extraction line(s) (6) for removing a pre-settable quantity of water (2) from the water reservoir (3) per unit of time, and one or more return line(s) (7) for returning the water (2) to the water reservoir (3);
a membrane filtration means (9) disposed in the recirculation means (4), which comprises a number of filter modules (10) fluidically connected in a parallel arrangement, and the filter modules (10) are connected to the extraction line or lines (6) by pipes that can be selectively shut off or opened to permit circulation on the intake side and on the filtrate side are connected to the return line or lines (7) by pipes that can be selectively shut off or opened to permit circulation, and in order to clean the filter modules (10), the filter modules (10) are connected to a backwashing liquid source (16) by pipes that can be selectively shut off or opened to permit circulation on the filtrate side and on the intake side are connected to a discharge (17) by pipes that can be selectively shut off or opened to permit circulation,
wherein it comprises a gas supply means (24), which, for cleaning the filter modules (10) of the membrane filtration means (9), is connected to the filter modules (10) by pipes that can be selectively shut off or opened to permit circulation on the intake side so that all of the filter modules (10) can be flushed with gas, and which gas supply means (24) is connected to the return line or lines (7) of the recirculation means (4) by pipes that can be selectively shut off or opened to permit circulation for circulating and mixing the water (2) in the water reservoir (3).

52. Water treatment system according to claim 51, wherein the filter modules (10) comprise at least two gas inlet connectors (28).

53. Water treatment system according to claim 51, wherein a shut-off member (15) co-operates with every filter module (10) of the membrane filtration means (9) on the filtrate side so that the filter modules (10) can be backwashed independently of one another in each case by means of the backwashing liquid source (16).

54. Water treatment system according to claim 51, wherein the filter modules (10) of the membrane filtration means (9) are connected to the extraction line or lines (6) via a common shut-off or flow-regulating member (14) on the intake side, and the filter modules (10) are connected to the discharge (17) via a common flow-regulating or shut-off member (18) on the intake side, and on the filtrate side, the filter modules (10) are connected to the return line or lines (7) of the recirculation means (4) and to the backwashing liquid source (16) via at least one switching means (19).

55. Water treatment system according to claim 51, wherein the backwashing liquid source (16) is provided in the form of a mains water supply (20).

56. Water treatment system according to claim 55, wherein the filter modules (10) are connected to the mains water supply (20) without a pumping device connected in between.

57. Water treatment system according to claim 55, wherein the mains water supply (20) for the filter modules (10) is provided with a pressure reducer (21).

58. Water treatment system according to claim 54, wherein the mains water supply (20) is provided with a metering device (22) for metering cleaning chemicals into the mains water.

59. Water treatment system according to claim 51, wherein the recirculation means (4) comprises a flow sensor (29) for detecting the quantity of water (2) flowing through the filter modules (10) during the filtration process.

60. Water treatment system according to claim 51, wherein the recirculation means (4) comprises at least two pressure sensors (30) for detecting the loss of pressure across the filter modules (10) during the filtration process.

61. Water treatment system according to claim 51, wherein the recirculation means (4) comprises an activated carbon filter (31).

62. Water treatment system according to claim 51, wherein the recirculation means (4) comprises an ion exchanger (34) for removing ionic nutrients.

63. Water treatment system according to claim 51, wherein it comprises a metering device (37) for adding fragrances to the water (2).

64. Water treatment system according to claim 51, wherein it comprises a metering device (35) for adding substances with an antimicrobial effect to the water (2).

65. Water treatment system according to claim 51, wherein the number and filtration capacity of the filter modules (10) are selected so that a removal rate of microorganisms that is greater than the growth rate of the microorganisms in the water (2) over the same period can be achieved by recirculating and filtering the water (2).

66. Water treatment system according to claim 51, wherein the number and filtration capacity of the filter modules (10) are selected so that the volume of water (2) contained in the water reservoir (3) overall can be filtered by the membrane filtration means (9) at least once a day and preferably between 2 times and 10 times.
